(19) United States
(12) Patent Application Publication
(10) Pub. No.: US 2004/0157606 A1
(43) Pub. Date: Aug. 12, 2004

(54) Automatic call connection method for a mobile communication terminal

(75) Inventor: Ho-Yeon Lee, Songnam-shi (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD, GYEONGGI-DO (KR)

(21) Appl. No.: 10/772,508

(22) Filed: Feb. 5, 2004

(30) Foreign Application Priority Data
Feb. 7, 2003 (KR) 7709-2003

(51) Int. Cl. H04Q 7/20

(52) U.S. Cl. 455/435.1; 455/450

(57) ABSTRACT

An automatic call connection method for a mobile communication terminal is disclosed. The method comprises storing call information used during initial call setup; determining whether unintentional call drop has occurred if an air message is not received for a previously set valid waiting time during a call using the call information; and generating, if it is determined that unintentional call drop has occurred, a message for providing notification of the unintentional call drop by a party that recognized the unintentional call drop, transmitting the generated message to the other party, and automatically connecting a previous call based on the stored call information.

### PRIORITY

This application claims priority under 35 U.S.C. § 119 to an application entitled “Automatic Call Connection Method for a Mobile Communication Terminal” filed in the Korean Industrial Property Office on Feb. 7, 2003 and assigned Serial No. 2003-7709, the contents of which are incorporated herein by reference.

### BACKGROUND OF THE INVENTION

1. Field of the Invention

The present invention relates generally to an automatic call connection method for a mobile communication terminal, and in particular, to an automatic call connection method for automatically connecting a previous call using previous call information stored previously, when an unintended call drop occurs during a voice call using a mobile communication terminal.

2. Description of the Related Art

In a mobile communication environment, there are instances where an unintended call drop (or call disconnection) occurs due to communication failure (e.g. impulsive fading) of a communication network while a user is conducting a voice call.

In this case, for call reconnection, one party (commonly, a caller or an originator) out of both parties who were conducting the voice call must redial a phone number of the other party. Then, between a mobile communication terminal (hereinafter referred to as a “terminal” for short) and a base station, a call setup procedure is performed according to a general call protocol, beginning at transmission of an origination message for call connection.

FIG. 1 illustrates a common procedure for connecting a call upon call drop of a mobile communication terminal. Referring to FIG. 1, if call drop occurs while a user of a terminal (MT) 10 is conducting a voice call with the other party through data exchange with a base station (BS) 20, a release order message for releasing the call is exchanged between the terminal 10 and the base station 20 (Step S11). The “release order message” refers to a message for notifying call drop between a terminal and a base station, and is transmitted by the terminal or the base station. That is, the release order message is a message transmitted by the party that first recognized call drop, and has a data format previously agreed upon by the terminal and the base station.

If a call is released through an exchange of the release order message between the terminal 10 and the base station 20, one party (commonly, a caller) who was conducting a voice call inputs (or redials) a corresponding phone number in order to call again the other party with whom he or she was talking over the phone, making a call attempt (Step S20). At this moment, the terminal 10 transmits information necessary for call connection (e.g., an origination message) to the base station 20 (Step S30). The base station 20 then assigns a channel for connecting the corresponding call by consulting the origination message (Step S40), and transmits a channel assignment message to the terminal 10 that has requested a call (Step S50). Upon receiving the channel assignment message, the terminal 10 sets up a traffic channel based on the channel assignment message (Step S60), makes service option negotiation with the base station 20 (Step S70), and then connects a new call (Step S80).

As stated above, in order to reconnect a dropped call, a series of call setup procedures (Steps S30 to S80) including the redialing work (Step S20) by the user must be implemented. As a result, a considerably long time delay occurs disadvantageously during call reconnection. In addition, the user must annoyingly redial a phone number of the other party with whom he or she was talking over the phone.

### SUMMARY OF THE INVENTION

It is, therefore, an object of the present invention to provide an automatic call connection method for automatically connecting a previous call when an unintentional call drop occurs during a call using a mobile communication terminal.

It is another object of the present invention to provide an automatic call connection method for automatically connecting a previous call using previous call information previously stored in a mobile communication terminal and a base station.

A further object of the present invention is to provide an automatic call connection method for allowing a user of a mobile communication terminal to reconnect a call without annoying redialing when an unintentional call drop occurs during a call using a mobile communication terminal.

It is yet another object of the present invention to provide an automatic call connection method for rapidly connecting a previous call when an unintentional call drop occurs during a call using a mobile communication terminal, enabling a continuous conversation.

To achieve the above and other objects, there is provided an automatic call connection method for a mobile communication terminal. The method comprises storing call information used during initial call setup; determining whether unintentional call drop has occurred, if an air message is not received for a previously set valid waiting time during a call using the call information; and generating, if it is determined that unintentional call drop has occurred, a message for notifying the unintentional call drop by a party that recognized the unintentional call drop, transmitting the generated message to the other party, and automatically connecting a previous call based on the stored call information.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a common procedure for connecting a call upon call drop of a mobile communication terminal;

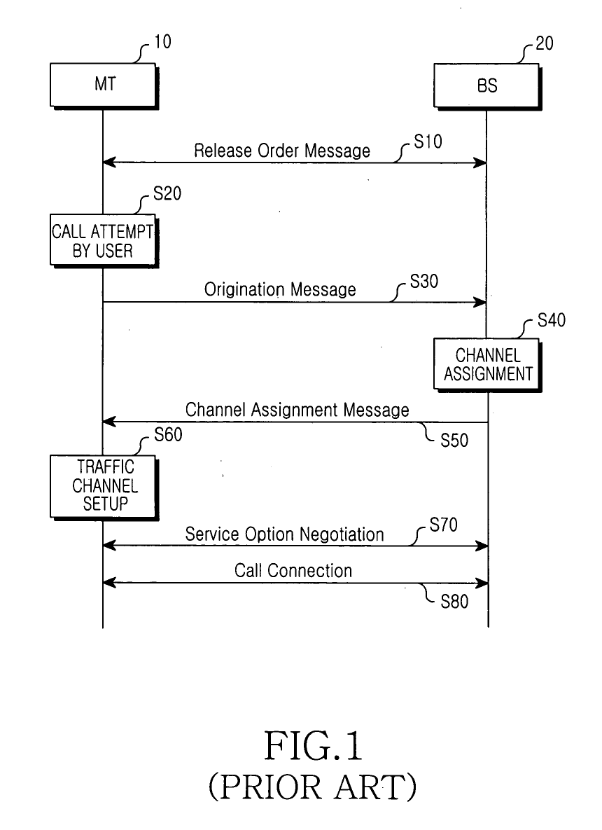

FIG. 2 illustrates a procedure for automatically connecting a call for a mobile communication terminal according to a first embodiment of the present invention;

FIG. 3 illustrates a procedure for automatically connecting a call for a mobile communication terminal according to a second embodiment of the present invention;

FIG. 4 illustrates a data format of an order message exchanged between a base station and a mobile communication terminal for automatic call connection of the mobile communication terminal, according to an embodiment of the present invention;

FIG. 5 is a flowchart illustrating an automatic call connection method for a mobile communication terminal according to first and second embodiments of the present invention;

FIG. 6 is a flowchart illustrating an automatic call connection process according to a first embodiment of the present invention; and

FIG. 7 is a flowchart illustrating an automatic call connection process according to a second embodiment of the present invention.

### DETAILED DESCRIPTION OF THE PREFERRED EMBODIMENTS

Several preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

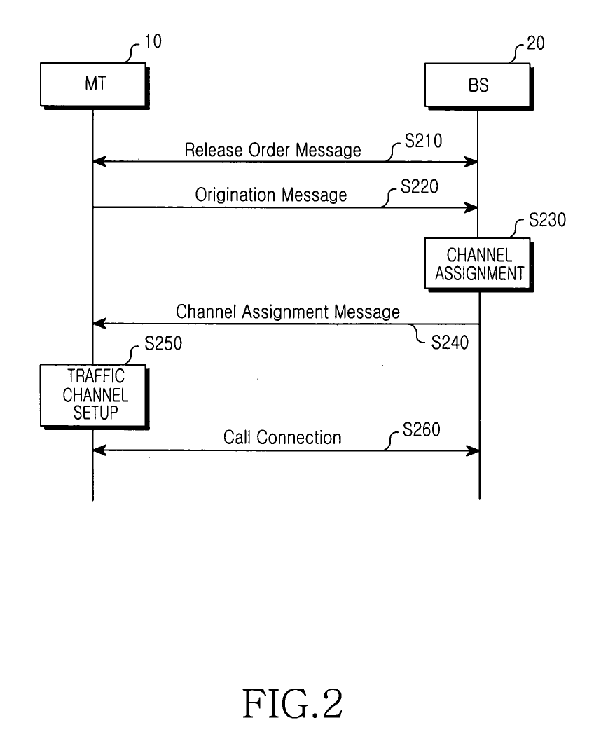

FIG. 2 illustrates a procedure for automatically connecting a call for a mobile communication terminal according to a first embodiment of the present invention. Referring to FIG. 2, if call drop occurs while a user of a terminal 10 is conducting a voice call with the other party through data exchange with a base station 20, a release order message for releasing the call is exchanged between the terminal 10 and the base station 20 (Step S210). The “release order message” refers to a message for providing notification of call drop between the terminal and the base station, and is transmitted by the terminal or the base station. That is, the release order message is a message transmitted by the party that first recognized call drop, and has a data format previously agreed between the terminal and the base station.

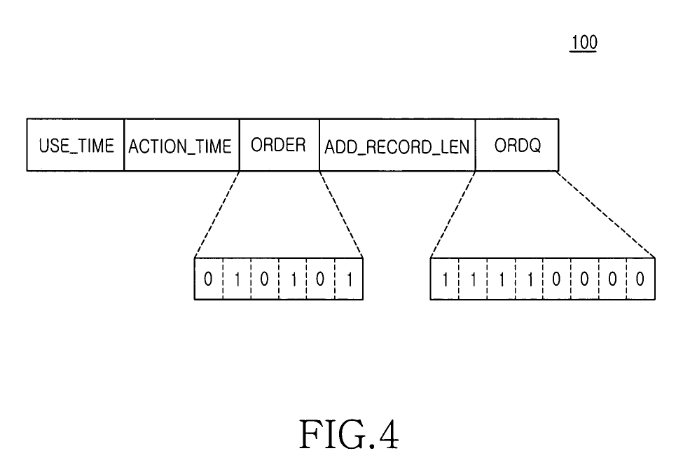

FIG. 4 illustrates a data format of an order message exchanged between the base station and the mobile communication terminal, for automatic call connection of the mobile communication terminal according to an embodiment of the present invention. Referring to FIG. 4, an order message typically includes USE_TIME, ACTION_TIME, ORDER, ADD_RECORD_LEN, and ORDQ fields.

The USE_TIME field represents whether to use the ACTION_TIME field, and the ACTION_TIME field stores a valid start time of the corresponding order message only when the USE_TIME field is set to ‘1’. The ORDER field stores a type of corresponding order message, and the ADD_RECORD_LEN field stores information of an entire length of the corresponding order message. Finally, the ORDQ field stores identification information of the corresponding order message.

The present invention records a predetermined value in the ORDQ field of the order message having such a field format before transmission, so that a mobile communication terminal and a base station can commonly recognize unintentional call drop.

Therefore, the release order message exchanged in step S210 between the terminal 10 and the base station 20 has the format illustrated in FIG. 4. That is, the terminal 10 or the base station 20 generates a release order message by recording a value (e.g., 010101) commonly used to indicate a type of the release order message in the ORDER field of the order message, and recording a value (e.g., 11110000) previously agreed to notify unintentional call drop in the ORDQ field of the order message, and transmits the generated release order message to the other party.

By sharing such a release order message, the terminal 10 and the base station 20 recognize occurrence of unintentional call drop, and perform a series of procedures (Steps S220 to S260) for automatically reconnecting the dropped call.

For example, in FIG. 2, the terminal 10 generates an origination message for reconnecting the dropped (i.e. previous) call using previously stored call information (e.g., the other party's phone number, a service option, etc.), and transmits the generated origination message to the base station 20 (Step S220).

The base station 20 then assigns a channel for connecting the corresponding call by consulting the origination message (Step S230), and transmits a channel assignment message to the terminal 10 (Step S240). Upon receiving the channel assignment message, the terminal 10 sets up a traffic channel based on the channel assignment message (Step S250), and reconnects the dropped call with the base station 20 (Step S260).

In this case, since a service option for the previous call is previously stored as previous call information, service option negotiation between the terminal 10 and the base station 20 is unnecessary.

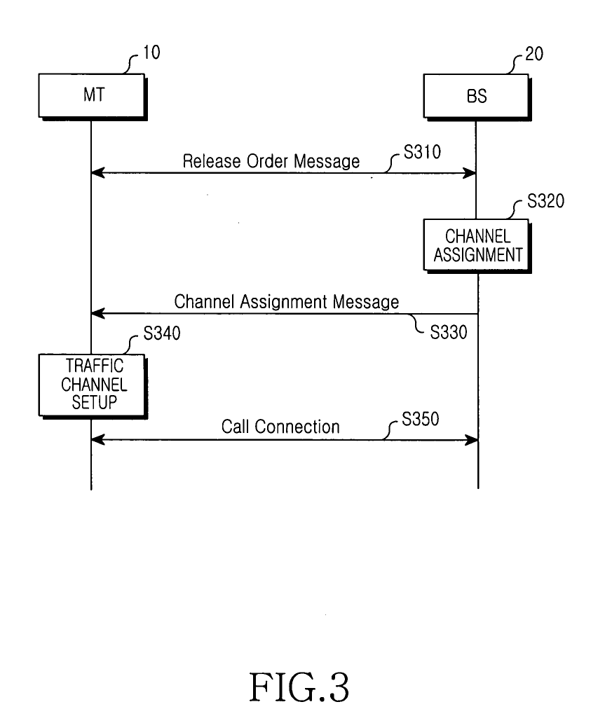

FIG. 3 illustrates a procedure for automatically connecting a call for a mobile communication terminal according to a second embodiment of the present invention. The procedure of FIG. 3 excludes a process of generating by a terminal 10 an origination message for call connection and transmitting the generated origination message to a base station 20, in order to automatically reconnect an unintentionally dropped call. In order to exclude the process of generating by the terminal 10 an origination message for call connection and transmitting the generated origination message to the base station 20, it should be assumed that previous call information is previously stored in the base station 20.

Referring to FIG. 3, if call drop occurs while a user of the terminal 10 is conducting a voice call with the other party through data exchange with the base station 20, a release order message for releasing the call is exchanged between the terminal 10 and the base station 20 (Step S310). This process is performed in a similar manner as described in conjunction with the step S210 of FIG. 2.

As a result of the process in step S310, the terminal 10 and the base station 20 share the release order message, so they can recognize occurrence of unintentional call drop.

The base station 20 then assigns a channel for reconnecting a corresponding call using previous call information (e.g., a phone number of a previously called party, a service option of the a previous call, etc.) previously stored therein (Step S320), and transmits a channel assignment message to the terminal 10 (Step S330). Upon receiving the channel assignment message, the terminal 10 sets up a traffic channel based on the channel assignment message (Step S340), and then connects the previous call (Step S350).

In this case, since a service option for the previous call is previously stored as previous call information, service option negotiation between the terminal 10 and the base station 20 is unnecessary.

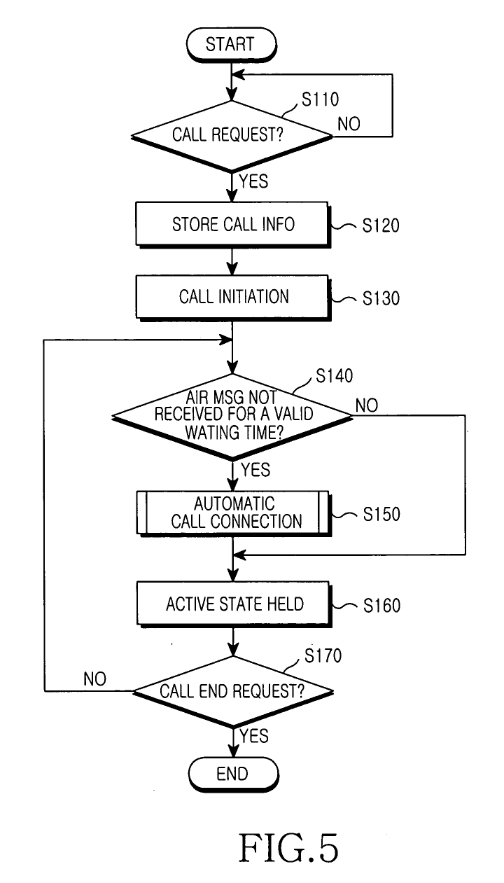

FIG. 5 is a flowchart illustrating an automatic call connection method for a mobile communication terminal according to first and second embodiments of the present invention. Referring to FIG. 5, in an automatic call connection method for a mobile communication terminal according to first and second embodiments of the present invention, if a user of a mobile communication terminal requests a call by pressing a CALL button in order to make an outgoing call or answers an incoming call (Step S110), the corresponding mobile communication terminal or base station stores call information (e.g., a phone number of the other party, a service option, etc.) used while connecting the call (Step S120). Thereafter, the mobile communication terminal or base station initiates a call using the call information (Step S130). The step S130 includes a series of general call connection processes (e.g., channel assignment, traffic channel setup, etc.). These call connection processes are well known to those skilled in the art, so a detailed description of the processes will not be made herein.

If an air message is not received for a valid waiting time previously set in the mobile communication terminal or base station during the call (Step S140), the corresponding mobile communication terminal or base station determines that the call is dropped due to a reason unintended by the user, such as channel loss.

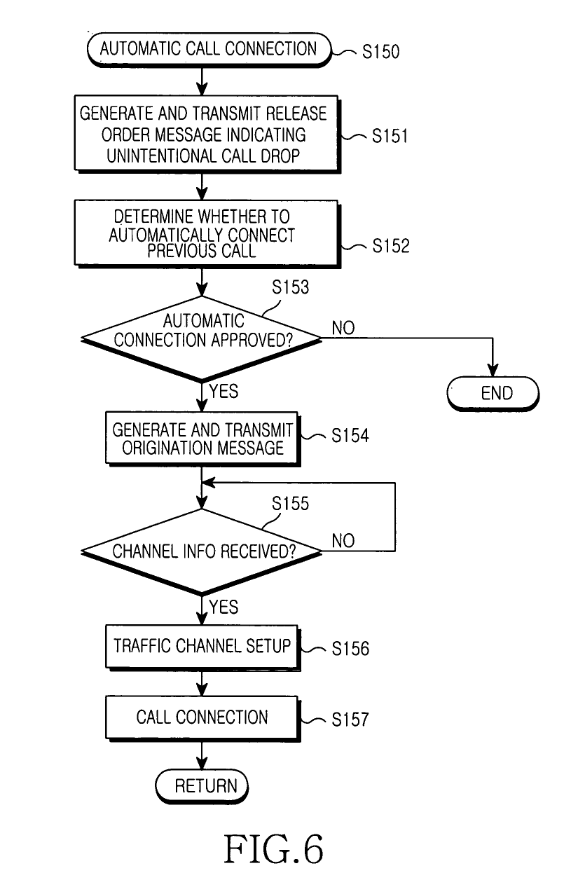

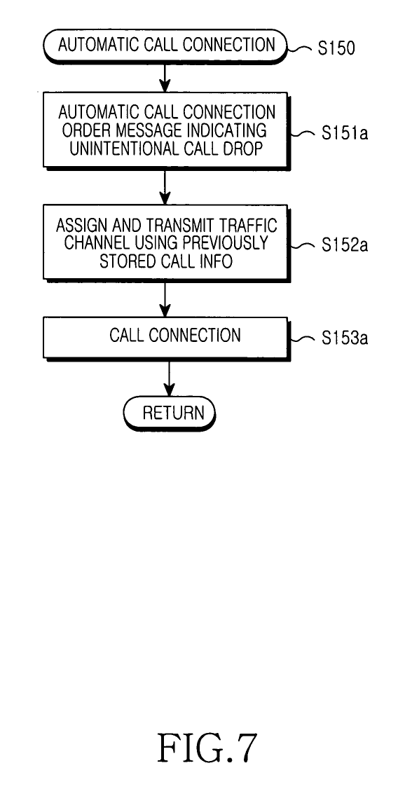

The mobile communication terminal or base station then automatically connects a previous call based on the call information previously stored in step S120 (Step S150). The mobile communication terminal or base station holds an active state (or call state) (Step S160) until the user requests call end, e.g. by pressing an END button (Step S170). The present invention proposes two different methods for the automatic call connection process (S150), and a detailed description of the different automatic call connection processes will be made with reference to FIGS. 6 and 7.

FIG. 6 is a flowchart illustrating an automatic call connection process according to a first embodiment of the present invention. Referring to FIG. 6, if one of the mobile communication terminal and the base station recognizes unintentional call drop in step S140, the mobile communication terminal or base station generates a message (e.g., a release order message) for providing notification of the unintentional call drop, and transmits the generated release order message to the other party (Step S151). The release order message has been described with reference to FIG. 4. The mobile communication terminal and the base station, sharing the release order message through step S151, will commonly recognize occurrence of the unintentional call drop.

Upon recognizing occurrence of the unintentional call drop, the mobile communication terminal informs the user of this fact and determines whether to automatically connect a previous call (Step S152). Thereafter, the mobile communication terminal receives a user's approval for automatically connecting the previous call (Step S153), and then generates an origination message for automatically connecting the previous call and transmits the generated origination message to the base station (Step S154). The mobile communication terminal generates the origination message using the call information (e.g., a phone number of the other party, a service option, etc.) previously stored in step S120 of FIG. 5.

If the base station transmits channel information for automatic connection of the previous call in response to the origination message, the mobile communication terminal receives the channel information (Step S155), and sets up a traffic channel based on the channel information (Step S156). Thereafter, the mobile communication system connects the previous call using the traffic channel (Step S157). In this case, a process of redialing by the user for reconnection of the previous call and a process of making service option negotiation on the previous call between the mobile communication terminal and the base station can be excluded.

FIG. 7 is a flowchart illustrating an automatic call connection process according to a second embodiment of the present invention. Referring to FIG. 7, if one of the mobile communication terminal and the base station recognizes unintentional call drop in step S140 (FIG. 5), the mobile communication terminal or base station generates a message (e.g., a release order message) for providing notification of the unintentional call drop, and transmits the generated release order message to the other party (Step S151a). The release order message has been described with reference to FIG. 4.

The mobile communication terminal and the base station, sharing the release order message through step S151a, will commonly recognize occurrence of the unintentional call drop. Upon recognizing occurrence of the unintentional call drop, the base station assigns a traffic channel for automatic connection of the previous call, using the call information (e.g., a phone number of the other party, a service option, etc.) previously stored in step S120 of FIG. 5, and transmits the traffic channel to all mobile communication terminals with which the base station was conducting the previous call (Step S152a). For example, if the previous call was a conference call, the base station transmits the traffic channel to all parties. Thereafter, the base station connects the previous call using the traffic channel (Step S153a).

The second embodiment of the present invention can exclude not only the process of redialing by the user for reconnection of the previous call and the process of making service option negotiation on the previous call between the mobile communication terminal and the base station, like the first embodiment, but also a process of generating by the mobile communication terminal an origination message for connection of the previous call and transmitting the origination message.

As described above, when unintentional call drop occurs during a call using a mobile communication terminal, a proposed automatic call connection method recognizes occurrence of the unintentional call drop, and automatically connects a previous call using previous call information stored previously, so a user of the mobile communication terminal is not required to redial for reconnection of the previous call. In addition, the proposed method automatically connects the previous call within a short time, minimizing discontinuity of the conversation. Furthermore, the proposed method can exclude a series of processes (e.g., service option negotiation, etc.) performed for call setup between a terminal and a base station, contributing to a reduction in a call connection time and a reduction in a waste of system resources for performing these processes.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An automatic call connection method for a mobile communication terminal, comprising the steps of:
storing call information used during initial call setup;
determining, if call drop occurs during a call using the call information, whether the call drop is an unintentional call drop; and
automatically reconnecting the dropped call based on the stored call information, if the call drop is determined to be unintentional.

2. The automatic call connection method of claim 1, wherein the determining step determines that unintentional call drop has occurred if an air message is not received for a valid waiting time previously set in one of a mobile communication terminal conducting the call and a base station controlling the call.

3. The automatic call connection method of claim 1, wherein the automatically reconnecting step further comprises:
(a) generating a message for providing notification of the unintentional call drop by one of the mobile communication terminal and the base station, and transmitting the generated message to an other party;
(b) generating an origination message for automatic reconnection of the dropped call using the call information stored by the mobile communication terminal upon receiving notification of the unintentional call drop;
(c) transmitting the generated origination message from the mobile communication terminal to the base station;
(d) receiving, by the mobile communication terminal, channel information for automatic reconnection of the dropped call from the base station, and setting up a traffic channel based on the received channel information; and
(d) connecting the dropped call using the traffic channel.

4. The automatic call connection method of claim 3, wherein step (a) comprises setting an order identifier (ORDQ) of a release order message indicating call end at a value previously agreed between the mobile communication terminal and the base station.

5. The automatic call connection method of claim 3, wherein step (b) comprises receiving a user's approval for automatic connection of the previous call by the mobile communication terminal.

6. The automatic call connection method of claim 1, wherein the automatically reconnecting step further comprises the steps of:
generating a message for providing notification of unintentional call drop by one of the mobile communication terminal and the base station, and transmitting the generated message to an other party;
assigning a traffic channel for automatic reconnection of the dropped call by the base station using the stored call information, upon receiving the generated message for providing notification of the unintentional call drop;
transmitting the traffic channel to all mobile communication terminals with which the base station was conducting the dropped call; and
connecting the dropped call using the traffic channel.

7. The automatic call connection method of claim 6, wherein the generating step further comprises setting an order identifier (ORDQ) of a release order message indicating call end at a value previously agreed between the mobile communication terminal and the base station.
